(19) United States
(12) Patent Application Publication
(10) Pub. No.: US 2026/0362511 A1
(43) Pub. Date: Nov. 12, 2026

(54) ANTENNA MANAGEMENT METHOD AND MULTI-ANTENNA DEVICE

(71) Applicant: Realtek Semiconductor Corporation, Hsinchu (TW)

(72) Inventor: Jia You WU, Hsinchu (TW)

(21) Appl. No.: 19/430,200

(22) Filed: Dec. 22, 2025

(30) Foreign Application Priority Data
May 8, 2025 (TW) 114117406

(51) Int. Cl. H04W 76/10; H01Q 21/28; H04W 52/02; H04W 84/12

(52) U.S. Cl. CPC H04W 76/10; H01Q 21/28; H04W 52/0274; H04W 84/12

(57) ABSTRACT

An antenna management method for managing a plurality of antennas, which are configured to establish at least one communication link with an external device, of a multi-antenna device comprises the following steps of: announcing that a first antenna of the antennas maintains within the at least one communication link and a second antenna of the antennas does not maintain within the at least one communication link; and, enabling the second antenna to perform a first function. Thereby, the multi-antenna device is capable of executing other wireless communication functions while maintaining the original operation channel with the external device, so as to decrease the latency and the overhead of flow. The surplus antenna hardware resources can also be disabled to decrease the additional power consumption.

### CROSS-REFERENCE TO RELATED APPLICATION

This application claims priority to Taiwan Application Serial Number 114117406, filed May. 08, 2025, which is herein incorporated by reference in its entirety.

### BACKGROUND

### Field of Invention

This disclosure relates to an antenna management method and a multi-antenna device, and in particular to a multi -antenna device and an antenna management method thereof that can execute other wireless communication functions without affecting the connection of the original operation channel.

### Description of Related Art.

The well-known multi-antenna device may include multiple antennas to establish a communication link with other wireless communication devices to transmit data. This communication link is the operation channel. When the multi-antenna device is about to execute other wireless communication functions, these antennas must temporarily leave the operation channel, which may increase the latency of transmission. For example, when a non-access point multi-antenna device is connected to an access point device and wants to execute a roaming function at the same time, the non-access point multi-antenna device needs to first register these antennas to the access point device as a doze state, and then the multiple antennas that originally maintain the operation channel within the access point device all leave the operation channel and search for the next new access point device to connect. During this period, the data packets to be transmitted by the original access point device and the multi-antenna device are temporarily stored, and then transmitted when the antenna of the non-access point multi-antenna device is restored to the operating channel, resulting in a transmission delay. In addition, enabling multiple antennas to maintain within the same operating channel may cause additional power consumption problems for the multi-antenna device. Therefore, it is necessary to solve the above-mentioned problems.

### SUMMARY

An embodiment of present disclosure relates to an antenna management method, which is applied to a multi-antenna device to manage a plurality of antennas in the multi-antenna device, wherein the antennas are configured to establish at least one communication link with an external device. the antenna management method comprises the following steps: announcing that a first antenna of the antennas maintains within the at least one communication link and a second antenna of the antennas does not maintain within the at least one communication link; and enabling the second antenna to execute a first function.

Another embodiment of the present disclosure discloses multi-antenna device, comprising a first antenna, a second antenna and a storage device, wherein, the first antenna and the second antenna are to establish at least one communication link with an external device. The storage device is configured to store an antenna link configuration profile, the antenna link configuration profile is configured to indicate a connection configuration of the first antenna and the second antenna when the multi-antenna device is connected to the external device. The processor is connected to the first antenna, the second antenna and the storage device, and the processor is configured to execute the following steps according to the antenna link configuration profile: announcing that the first antenna maintains within the at least one communication link and the second antenna does not maintain within the at least one communication link; and enabling the second antenna to execute a first function.

In summary, when the multi-antenna device is connected to an external device to established an operation channel, part of the antenna can maintain the original operation channel within the external device through an announcement method, and the other part of the antenna can leave the original operation channel and execute other wireless communication functions or enter the shutdown state. Therefore, when the multi-antenna device can still transmit data with the external device, other functions can be executed at the same time without affecting the original connection, so that the latency and additional power consumption of the original transmission channel can be reduced.

### BRIEF DESCRIPTION OF THE DRAWINGS

FIG. 1 is a schematic diagram of the structure of a multi-antenna device in accordance with some embodiments of the present disclosure.

FIG. 2 is a flow chart of an antenna management method in accordance with some embodiments of the present disclosure.

FIG. 3A is a flow chart of an antenna management method in accordance with some embodiments of the present disclosure.

FIG. 3B is a flow chart of an antenna management method in accordance with some embodiments of the present disclosure.

FIG. 4A is a flow chart of the antenna management method for controlling the multi-antenna device to execute a channel scanning function in accordance with some embodiments of the present disclosure.

FIG. 4B is a flow chart of the antenna management method for controlling the multi-antenna device to execute a roaming function in accordance with some embodiments of the present disclosure.

FIG. 4C is a flow chart of the antenna management method for controlling the multi-antenna device to execute a channel switching announcement function in accordance with some embodiments of the present disclosure.

### DETAILED DESCRIPTION

The embodiments are described in detail below with reference to the appended drawings to better understand the aspects of the present disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms "coupled" or "connected" as used herein may mean that two or more elements are directly in physical or electrical contact, or are indirectly in physical or electrical contact with each other. It can also mean that two or more elements interact with each other.

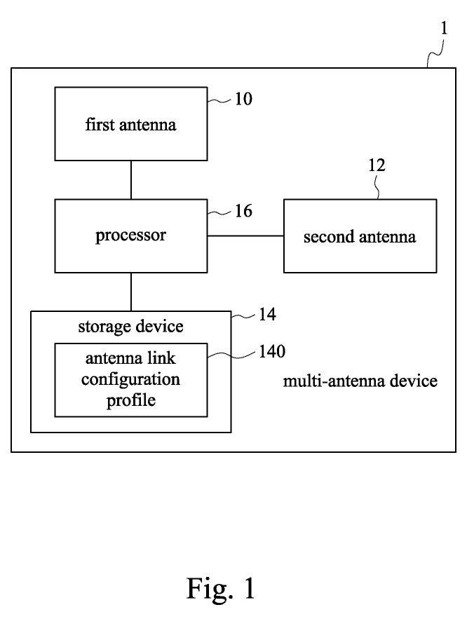

Referring to FIG. 1, FIG. 1 is a schematic diagram of the structure of a multi-antenna device 1 in accordance with some embodiments of the present disclosure. As shown in FIG. 1, the multi-antenna device 1 comprises a first antenna 10, a second antenna 12, a storage device 14, and a processor 16. The first antenna 10 and the second antenna 12 may be connected to an external device. In some embodiments, the first antenna 10 and the second antenna 12 may be connected to the external device through the same communication link or through different communication links. For example, the first antenna 10 and the second antenna 12 may be connected to the external device through the communication link marked as Link0 at the same time, or they may be connected to the external device through channels marked as Link0 and Link1 respectively. The storage device 14 stores an antenna link configuration profile 140. When the multi-antenna device 1 is connected to an external device, the antenna link configuration profile 140 may be a protocol indicating which communication link each antenna is configured within. For example, in the antenna link configuration profile 140, the protocol status for the first antenna 10 and the second antenna 12 mentioned above being connected to the external device through the communication link labeled Link0 at the same time is 2+0, and the protocol status for the first antenna 10 and the second antenna 12 being connected to the external device through the channels labeled Link0 and Link1, respectively, is 1+1. The processor 16 may control the first antenna 10 and the second antenna 12 to communicate with the external device according to the antenna link configuration profile 140 in the storage device 14. Please note that in the embodiment of FIG. 1, the multi-antenna device 1 comprises two antennas, but this is not limited to practice. The multi-antenna device 1 is able to comprise three or more multi-antennas.

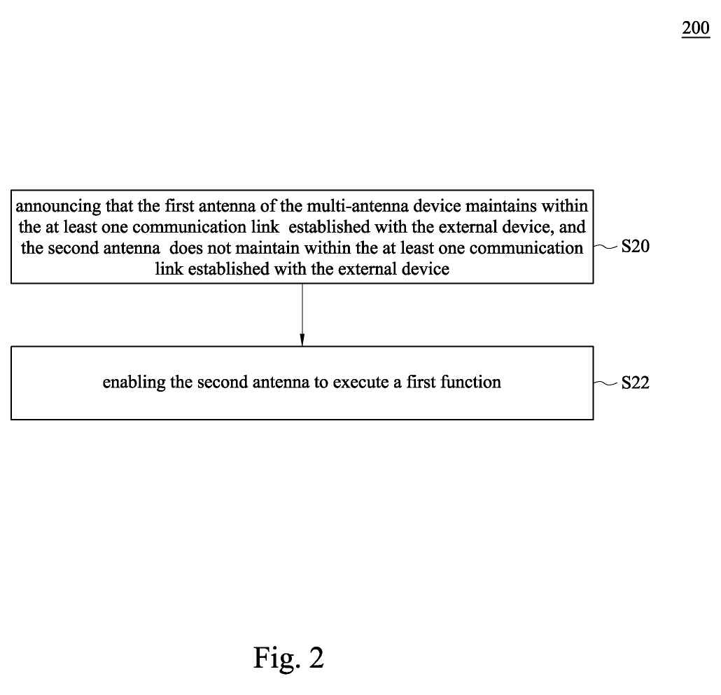

Referring to FIG. 2, FIG. 2 is a flow chart of an antenna management method 200 in accordance with some embodiments of the present disclosure. Please note that the antenna management method 200 of FIG. 2 may be implemented by the multi-antenna device 1 in FIG. 1, so the description of the embodiment of FIG. 2 may also refer to each unit in the multi-antenna device 1 of FIG. 1. As shown in FIG. 2, in some embodiments, the antenna management method 200 is applied to the multi-antenna device 1 mentioned above, and the first antenna 10 and the second antenna 12 comprised in the multi-antenna device 1 may establish at least one communication link with an external device, such as the aforementioned Link0 and Link1 channels. The antenna management method 200 comprises the following steps: step S20, announcing that the first antenna 10 of the multi-antenna device 1 maintains within the at least one communication link (i.e., operation channel) established with the external device, and the second antenna 12 does not maintain within the at least one communication link established with the external device; and step S22: enabling the second antenna to execute a first function.

Through the above steps, the first antenna 10 and the second antenna 12, which originally maintained within the operation channel with the external device at the same time, which the second antenna 12 is separated from the operation channel and executes other functions, while the first antenna 10 is still maintained within the original operation channel and can be continuously connected to the original external device, so the data to be transmitted does not need to be temporarily stored and can be directly transmitted. Therefore, even if the multi-antenna device 1 executes other wireless communication functions, the original connection transmission may not have latency.

In some embodiments, the announcement in step S20 is executed by the processor 16 according to the protocol in the antenna link configuration profile 140, that is, when the multi-antenna device 1 is about to start executing multiple functions, the processor 16 may announce the change of the protocol state according to the antenna link configuration profile 140, for example, announcing that the protocol state 2+0 mentioned above is changed to 1+0, or announcing that the protocol state 1+1 is changed to 1+0. However, the announcement mentioned above is only that the multi-antenna device 1 changes the antenna protocol state between the external device originally connected, but the hardware configuration of the multi-antenna device 1 itself is not changed.

In step S22, the first function executed by the second antenna 12 is a function different from the original connection, which may be different according to the type of the multi-antenna device 1. In some embodiments, the multi-antenna device 1 is a non-access point (AP) multi-antenna device, and its first function may be wireless communication functions that can be executed by the non-access point multi-antenna device, such as a channel scanning function, a roaming function, a shutdown function, an 802.11 AZ positioning function, an 802.11 BF WiFi sensing function, and a wireless communication function that shares an antenna with WiFi. In other embodiments, the multi-antenna device 1 is an access point multi-antenna device, and its first function may be wireless communication functions that can be executed by an access point multi-antenna device, such as a channel switching announcement function, the shutdown function, a dynamic frequency selection function, the 802.11 AZ positioning function, the 802.11 BF WiFi sensing function, and a wireless communication function that shares an antenna with WiFi. The shutdown function mentioned above refers to the second antenna 12 temporarily shutting down, dozing, or entering a power saving state, which can reduce the power consumption of the multi-antenna device 1. In addition, the wireless communication function that shares an antenna with WiFi mentioned above can comprised but is not limited to Bluetooth, ZigBee, Thread and other wireless communication functions.

As mentioned above, when the first antenna 10 and the second antenna 12 establish a communication link with the external device, they can be connected to the external device through the communication link marked as Link0 at the same time, or they can be connected to the external device through the communication links marked as Link0 and Link1 respectively, which is based on the type of the multi-antenna device 1. For example, if the multi-antenna device 1 is a non-access point multi-antenna device of MLMR (Multi-Link Multi Radio) type, the first antenna 10 and the second antenna 12 can be connected to the external device through the communication links of Link0 and Link1, and when the multi-antenna device 1 is a non-access point multi-antenna device of MLSR (Multi-Link Single Radio) type or eMLSR (Enhanced MLSR) type, the first antenna 10 and the second antenna 12 are connected to the external device through the communication link of Link0.

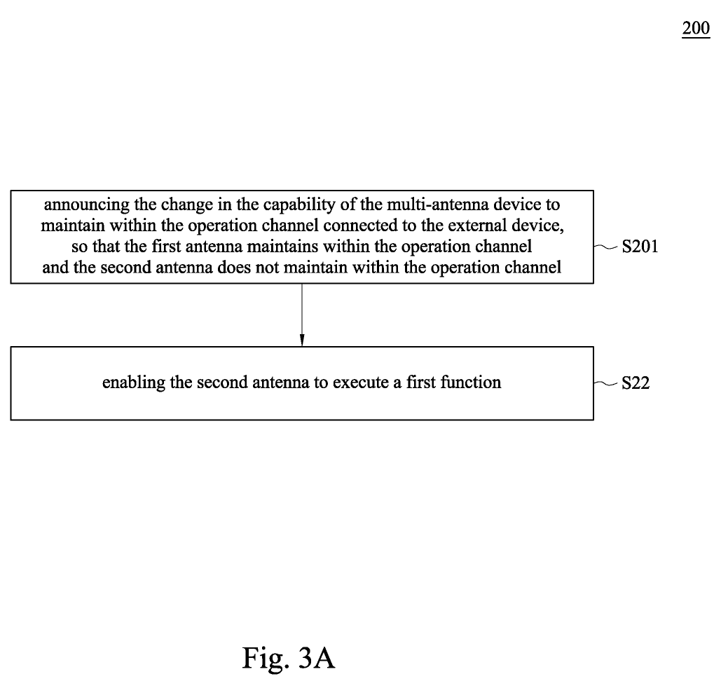

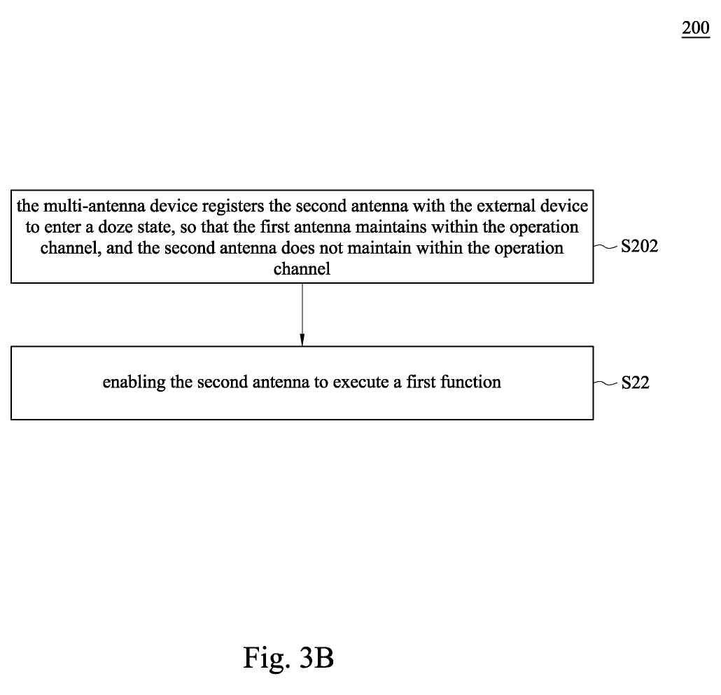

Based on the differences of the multi-antenna device 1, the antenna management method disclosed herein also has corresponding embodiments. Referring to FIGS. 3A and 3B, FIG. 3A is a flow chart of the antenna management method 200 in accordance with some embodiments of the present disclosure, and FIG. 3B is a flow chart of the antenna management method in accordance with some other embodiments of the present disclosure.

In the embodiment shown of FIG. 3A, the antenna management method 200 is configured for the aforementioned MLSR or eMLSR type non-access point multi-antenna device, and the antenna management method 200 further comprises the following steps: Step S201, announcing the change in the capability of the multi-antenna device 1 to maintain within the operation channel connected to the external device, so that the first antenna 10 maintains within the operation channel and the second antenna 12 does not maintain within the operation channel. The other steps of the antenna management method 200 of the embodiment of FIG. 3A are the same as the corresponding steps of the embodiment mentioned above, and thus are not repeated here.

Since the antenna management method 200 of the embodiment of FIG. 3A is configured for the MLSR or eMLSR type non-access point multi-antenna device mentioned above, the multi-antenna device and the external device establish a communication link Link0 (operation channel) with the external device through the first antenna 10 and the second antenna 12 (or, in other embodiments, the multi-antenna device 1 has a third antenna), and the agreement state at this time is 2+0. Therefore, step S201 is that the multi-antenna device 1 announces that the agreement state maintained in the operation channel is changed to 1+0, and at this time the second antenna 12 leaves the communication link Link0 and can be configured to execute other functions. Alternatively, in some other embodiments, the multi-antenna device and the external device establish a communication link Link1 with the external device through the first antenna 10 and the second antenna 12, and the protocol state at this time is 0+2, and step S201 is that the multi-antenna device 1 announces that the protocol state maintains within the operation channel is changed to 0+1, and at this time the second antenna 12 leaves the communication link Link1 and can be configured to execute other functions.

In the embodiment shown in FIG. 3B, the antenna management method 200 is configured for the MLMR type non-access point multi-antenna device mentioned above, and further comprises the following steps: Step S202, the multi-antenna device 1 registers the second antenna 12 with the external device to enter a doze state, so that the first antenna 10 maintains within the operation channel, and the second antenna 12 does not maintain within the operation channel. The other steps of the antenna management method 200 of the embodiment of FIG. 3B are the same as the corresponding steps of the embodiment mentioned above, and thus are not repeated here.

Since the antenna management method 200 of the embodiment of FIG. 3B is configured for the MLMR type non-access point multi-antenna device mentioned above, the multi-antenna device and the external device respectively establish two communication links Link0, Link1 between the multi-antenna device and the external device through the first antenna 10 and the second antenna 12 (or, in other embodiments, the multi-antenna device 1 has the third antenna), both of which are operation channels between the multi-antenna device 1 and the external device, and the agreement state at this time is 1+1. Therefore, step S202 is that the multi-antenna device 1 announces that the agreement state maintains within the operation channel is changed to 1+0, that is, the first antenna 10 still maintains within the communication link Link0 but the second antenna 12 leaves the communication link Link1, so at this time the second antenna 12 can be configured to execute other functions.

As mentioned above, the first function that the second antenna 12 of the non-access point multi-antenna device can execute after leaving the operation channel may comprise a variety of wireless communication functions that the non-access point multi-antenna device can execute. The following describes the actual executing method of the antenna management method disclosed in the present disclosure when its first function is the channel scanning function and the roaming function.

In some embodiments, when the MLSR or eMLSR type non-access point multi-antenna device (multi-antenna device 1) has been connected to an external device, the protocol state of the connection is 2+0, and when it is about to execute the channel scanning function, according to the antenna management method mentioned above, the multi-antenna device 1 may first announce that the protocol state maintained in the operation channel is changed to 1+0, and at this time the second antenna 12 leaves the operation channel and starts scanning the communication link with other external devices. During the scanning process of the second antenna 12, the first antenna 10 always maintains within the operation channel with the original external device, so the multi-antenna device 1 can still continuously communicate with the original external device and transmit data during this period. Therefore, the multi-antenna device 1 executing the channel scanning function may not cause a communication latency with the original external device.

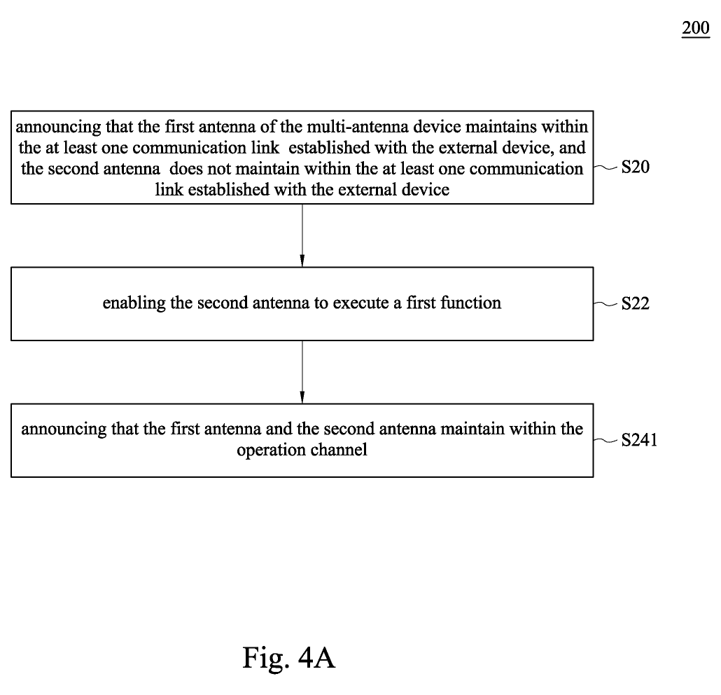

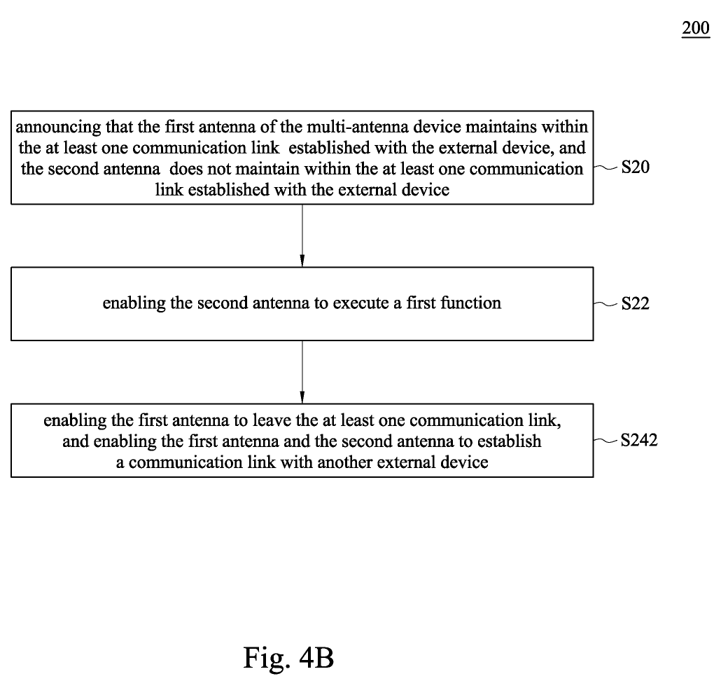

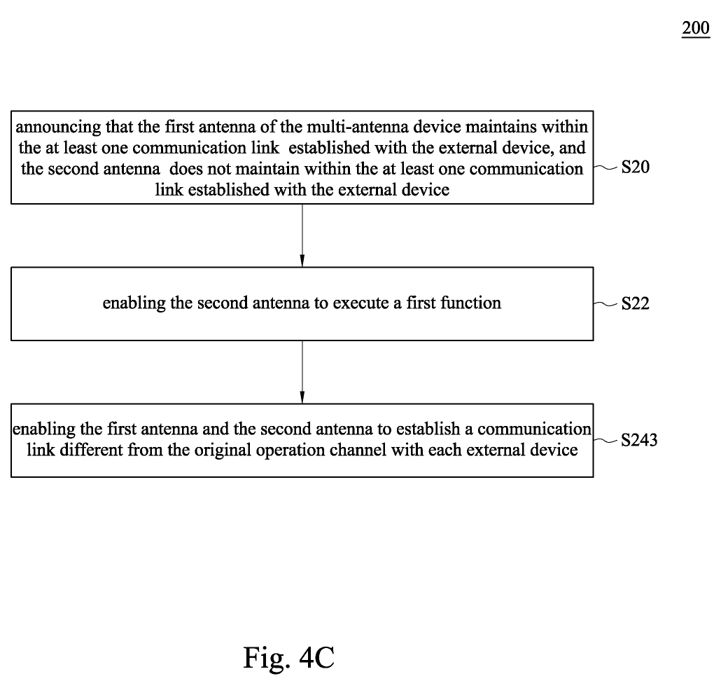

In addition, referring to FIG. 4A, FIG. 4A is a flow chart of the antenna management method 200 for controlling the multi-antenna device to execute the channel scanning function in accordance with some embodiments of the present disclosure. As shown in FIG. 4A, the antenna management method 200 further comprises step S241, which is after the second antenna 12 completes the first function, it announces that the first antenna 10 and the second antenna 12 maintain within the operation channel. Step S241 is after the second antenna 12 of the multi-antenna device 1 completes the channel scanning function, by changing the protocol state to 2+0 again, the second antenna 12 returns to the at least one communication link (i.e., the original operation channel) with the external device and provides the communication function with the original external device together with the first antenna 10. The other steps of the antenna management method 200 of the embodiment of FIG. 4A are the same as the corresponding steps of the embodiment mentioned above, so thus are not repeated here.

Similarly, in some embodiments, when the MLMR type non-access point multi-antenna device (multi-antenna device 1) has been connected to an external device, the protocol state of the connection is 1+1, and when it is about to execute the channel scanning function, according to the antenna management method mentioned above, the multi-antenna device 1 may first announce that the protocol state maintained within the operation channel is changed to 1+0, that is, the second antenna 12 is registered as a doze state, and at this time the second antenna 12 may leave its operation channel (such as the Link1 mentioned above) and start scanning the communication link with other external devices. Similarly, during the scanning process of the second antenna 12, the first antenna 10 always maintains within the operation channel (such as the Link0 mentioned above) with the original external device, so the multi-antenna device 1 can still continuously communicate with the original external device and transmit data during this period. Therefore, the multi-antenna device 1 executing the channel scanning function may not cause the communication latency with the original external device. Similarly, referring to FIG. 4A, in step S241, after the second antenna 12 completes the channel scanning function, the second antenna 12 returns to the original operation channel (Link 1) by changing the protocol state to 1+1 again, thereby providing the communication function with the original external device.

On the other hand, in some embodiments, when the MLSR or eMLSR type non-access point multi-antenna device (multi-antenna device 1) has been connected to an external device, the protocol state of the connection is 2+0, and when it is about to execute the roaming function, according to the antenna management method mentioned above, the multi-antenna device 1 may first announce that the protocol state maintained within the operation channel has changed to 1+0, and at this time the second antenna 12 leaves the operation channel and starts detecting the communication link between other external devices to determine the next external device to be connected. During the detecting process of the second antenna 12, the first antenna 10 always maintains within the operation channel between the original external device, so the multi-antenna device 1 may still continuously communicate with the original external device and transmit data during this period. Therefore, the multi-antenna device 1 executing the roaming function may not cause the communication latency with the original external device.

In addition, referring to FIG. 4B, FIG. 4B is a flow chart of the antenna management method 200 for controlling the multi-antenna device to execute a roaming function in accordance with some embodiments of the present disclosure. As shown in FIG. 4B, the antenna management method 200 further comprises step S242, which is after the second antenna 12 completes the first function, enabling the first antenna 10 to leave the at least one communication link (i.e., the original operation channel) with the original external device, and enabling the first antenna 10 and the second antenna 12 to establish a communication link with another external device, thereby connecting to the next external device to achieve the roaming function. The other steps of the antenna management method 200 of the embodiment of FIG. 4B are the same as the corresponding steps of the embodiment mentioned above, so thus are not repeated here.

Similarly, in some embodiments, when the MLMR type non-access point multi-antenna device (multi-antenna device 1) has been connected to an external device, the protocol state of the connection is 1+1, and when it is about to execute the roaming function, according to the antenna management method mentioned above, the multi-antenna device 1 may first announce that the protocol state maintained in the operation channel is changed to 1+0, that is, the second antenna 12 is registered as a doze state, and at this time the second antenna 12 may leave its operation channel (such as the Link1 mentioned above) and start detecting the communication link between other external devices to determine the next external device to be connected. Similarly, during the scanning process of the second antenna 12, the first antenna 10 always maintains the operation channel (such as the Link0 mentioned above) between the original external device, so the multi-antenna device 1 can still continuously communicate with the original external device and transmit data during this period. Therefore, the multi-antenna device 1 may not cause the communication latency with the original external device when executing the roaming function. Similarly, referring to FIG. 4B, in step S242, after the second antenna 12 executes the roaming function, the first antenna 10 leaves the original operation channel, and the first antenna 10 and the second antenna 12 establish communication links with another external device to achieve the roaming function. The difference from the previous embodiment is that the first antenna 10 and the second antenna 12 of this embodiment respectively establish two communication links (Link0 and Link1) with the other external device, and these two communication links are new operation channels.

In the embodiment above for the multi-antenna device 1 to execute the roaming function at the same time, if it is found that the connection between the multi-antenna device 1 and the selected new external device is not stable or it is not the external device with the best connection quality, the antenna management method 200 can be restarted to find the external device with the best connection quality, that is, the second antenna 12 announces to leave the operation channel again and to explore communication links of other external devices, and the first antenna 10 and the second antenna 12 are allowed to establish communication links with the newly found external device. Alternatively, in other embodiments, when the second antenna 12 explores communication links of other external devices, the connection quality between the second antenna 12 and these other external devices can be compared to determine that the other external devices with better or best quality may become the next external device to be connected.

On the other hand, as mentioned above, the first function that can be executed by the second antenna 12 of the access point multi-antenna device after leaving the operation channel may comprise a variety of wireless communication functions that can be executed by the access point multi-antenna device. The following describes the actual execution method of the antenna management method in this disclosure when the first function is the channel switching announcement function.

In some embodiments, when the multi-antenna device 1 as an access point device has connected to one or more external devices, it can connect to these external devices through one of the multiple communication links (for example, the communication link CHA in the communication links CHA~CHD), and the protocol state of the connection is 2+0. When the multi-antenna device 1 is about to execute the channel switching announcement function, it may first detect the communication links CHB~CHD to find a cleaner and more suitable communication link, and then announce to all connected external devices to switch the communication link. According to the antenna management method mentioned above, the multi-antenna device 1 may first announce that the protocol state maintains within the operation channel has changed to 1+0. At this time, the second antenna 12 leaves the operation channel (the communication link CHA) and starts scanning the other communication links CHB~CHD, and returns to the communication link CHA after the scanning is completed. Then, the multi-antenna device 1 may announce the communication link to be switched (for example, the multi-antenna device 1 is about to switch to the communication link CHB).to each external device During the process of the second antenna 12 scanning different communication links, the first antenna 10 always maintains within the operation channel CHA with each of the external devices, so the multi-antenna device 1 may still continuously communicate with each of the external devices and transmit data during this period. Therefore, the multi-antenna device 1 executing the channel scanning function may not cause the communication latency with the original external device.

In addition, referring to FIG. 4C, FIG. 4C is a flow chart of the antenna management method 200 for controlling the multi-antenna device to execute the channel switching announcement function in accordance with some embodiments of the present disclosure. As shown in FIG. 4C, the antenna management method 200 further comprises step S243, which is after the second antenna 12 completes the first function, enabling the first antenna 10 and the second antenna 12 to establish a communication link different from the original operation channel with each external device. Step S243 is when the second antenna 12 of the multi-antenna device 1 completes the channel switching announcement function, the first antenna 10 and the second antenna 12 switch to the selected new communication link (such as the communication link CHB mentioned above) and configure it as a new operation channel. The other steps of the antenna management method 200 of the embodiment of FIG. 4C are the same as the corresponding steps of the embodiment mentioned above, so thus are not repeated here.

In the embodiment mentioned above, the multi-antenna device has two antennas, but the present disclosure is not limited thereto, and the multi-antenna device may have three or more antennas. For a multi-antenna device having three or more multi-antennas, the antenna management method in the present disclosure has the same steps, for example, if the protocol state of the connection between the multi-antenna device and the original external device may be 3+0, that is, three antennas maintain within the communication link Link0, or the protocol state may be 2+1, that is, two antennas maintain within the communication link Link0 and one antenna maintains within the communication link Link1. According to the antenna management method mentioned above, when the multi-antenna device is to execute the first function, it can first announce that the protocol state is changed from 3+0 to 2+0, so that one of the antennas leaves the operation channel to execute the first function, or the antenna maintaining within the Link1 in the protocol state 2+1 is registered as the doze state (the protocol state is changed to 2+0), so that it leaves the operation channel to execute the first function.

The non-access point multi-antenna device mentioned above may connect to an access point device through multiple antennas for a single operating channel or multiple operating channels. However, some old type access point devices, such as access point devices before WiFi 7, do not have the function of multiple communication links. Therefore, the non-access point multi-antenna device connects to such access point devices through the same communication link using the antennas it has. For example, the first antenna 10 and the second antenna 12 of the non-access point multi-antenna device 1 mentioned above are connected to the access point device through the communication link Link0 at the same time, that is, their protocol statuses are 2+0. Therefore, the antenna management method 200 mentioned above can keep the multi-antenna device 1 connecting to the access point device through the same steps while executing other wireless communication functions.

In summary, the antenna management method in the present disclosure is configured for a multi-antenna device. It is to change the protocol status of the connection between the antenna in the multi-antenna device and the external device by announcing a change, so that a part of the antenna maintains within the operation channel, and the other part of the antenna is enabled to execute other wireless communication functions or enter the shutdown state, the doze state, or the power saving state. When the other part of the antenna is enabled to execute other wireless communication functions, since the part of the antenna still maintains within the operation channel with the original external device, the multi-antenna device can still continue to communicate with the original external device and transmit data to reduce latency. When the other part of the antenna is enabled to enter the shutdown state, the doze state, or the power saving state, since the part of the antenna still maintains within the operation channel with the original external device, the power consumption of the connection between the multi-antenna device and the external device can be reduced.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. An antenna management method, applied to a multi-antenna device to manage a plurality of antennas in the multi-antenna device, wherein the antennas are configured to establish at least one communication link with an external device, the antenna management method comprises:
announcing that a first antenna of the antennas maintains within the at least one communication link and a second antenna of the antennas does not maintain within the at least one communication link; and
enabling the second antenna to execute a first function.

2. The antenna management method of claim 1, wherein the multi-antenna device is a non-access point multi-antenna device, and the first function comprises a channel scanning function, a roaming function, a shutdown function, an 802.11 AZ positioning function, an 802.11 BF WiFi sensing function, and a wireless communication function that shares an antenna with WiFi.

3. The antenna management method of claim 2, wherein the first antenna and the second antenna jointly establish a first communication link of the at least one communication link with the external device, the antenna management method further comprises:
announcing a change in a capability of the multi-antenna device to maintain within the first communication link, so that the first antenna maintains within the first communication link and the second antenna does not maintain within the first communication link.

4. The antenna management method of claim 2, wherein the first antenna establishes a first communication link of the at least one communication link with the external device, and the second antenna establishes a second communication link of the at least one communication link with the external device, the antenna management method further comprises:
enabling the multi-antenna device to register with the external device that the second antenna enters a doze state, so that the first antenna maintains within the at least one communication link, and the second antenna does not maintain within the at least one communication link.

5. The antenna management method of claim 2, wherein when the first function is the channel scanning function, the antenna management method further comprises:
after the second antenna executes the first function, announcing that the first antenna and the second antenna maintain within the at least one communication link.

6. The antenna management method of claim 2, wherein when the first function is the roaming function, the antenna management method further comprises:
after the second antenna executes the first function, enabling the first antenna not to maintain within the at least one communication link, and enabling the first antenna and the second antenna to establish a third communication link with a second external device.

7. The antenna management method of claim 2, wherein when the first function is the shutdown function, a step of enabling the second antenna to execute the first function is to enable the second antenna to enter a shutdown state, a doze state, or a power saving state.

8. The antenna management method of claim 1, wherein the multi-antenna device is an access point multi-antenna device, and the first function comprises a channel switching announcement function, a shutdown function, a dynamic frequency selection function, an 802.11 AZ positioning function, an 802.11 BF WiFi sensing function, and a wireless communication function that shares an antenna with WiFi.

9. The antenna management method of claim 8, wherein the first antenna and the second antenna jointly establish a first communication link of the at least one communication link with the external device, the antenna management method further comprises:
announcing a change in a capability of the multi-antenna device to maintain within the first communication link, so that the first antenna maintains the first communication link and the second antenna does not maintain within the first communication link.

10. The antenna management method of claim 8, wherein when the first function is the channel switching announcement function, the antenna management method further comprises:
after the second antenna executes the first function, enabling the first antenna and the second antenna to establish a fourth communication link different from the at least one communication link with the external device.

11. The antenna management method of claim 8, wherein when the first function is the channel switching announcement function, the antenna management method further comprises:
after announcing that the second antenna does not maintain within the at least one communication link, enabling the second antenna to execute a channel scanning function to find a most suitable communication link with the external device; and
according to a result of the second antenna executing the channel scanning function, enabling the second antenna to execute the first function.

12. The antenna management method of claim 8, wherein when the first function is the shutdown function, a step of enabling the second antenna to execute the first function is to enable the second antenna to enter a shutdown state, a doze state, or a power saving state.

13. A multi-antenna device, comprising:
a first antenna, configured to establish at least one communication link with an external device;
a second antenna, configured to establish the at least one communication link with the external device;
a storage device, configured to store an antenna link configuration profile, wherein the antenna link configuration profile is configured to indicate a connection configuration of the first antenna and the second antenna when the multi-antenna device is connected to the external device; and
a processor, connected to the first antenna, the second antenna and the storage device, and the processor is configured to execute following steps according to the antenna link configuration profile:
announcing that the first antenna maintains within the at least one communication link and the second antenna does not maintain within the at least one communication link; and
enabling the second antenna to execute a first function.

14. The multi-antenna device of claim 13, wherein the multi-antenna device is a non-access point multi-antenna device, and the first function comprises a channel scanning function, a roaming function, a shutdown function, an 802.11 AZ positioning function, an 802.11 BF WiFi sensing function, and a wireless communication function that shares an antenna with WiFi.

15. The multi-antenna device of claim 14, wherein when the first antenna and the second antenna jointly establish a first communication link of the at least one communication link with the external device, the processor is configured to execute following steps according to the antenna link configuration profile:
announcing a change in a capability of the multi-antenna device to maintain within the first communication link, so that the first antenna maintains within the first communication link and the second antenna does not maintain within the first communication link.

16. The multi-antenna device of claim 14, wherein when the first antenna establishes a first communication link of the at least one communication link with the external device, and the second antenna establishes a second communication link of the at least one communication link with the external device, the processor is configured to execute following steps according to the antenna link configuration profile:
registering with the external device that the second antenna enters a doze state, so that the first antenna maintains within the at least one communication link, and the second antenna does not maintain within the at least one communication link.

17. The multi-antenna device of claim 14, wherein when the first function is the shutdown function, the processor is configured to shut down the second antenna or enable the second antenna to enter a doze state or a power saving state to reduce a power consumption of the multi-antenna device.

18. The multi-antenna device of claim 13, wherein the multi-antenna device is an access point multi-antenna device, and the first function comprises a channel switching announcement function, a shutdown function, a dynamic frequency selection function, an 802.11 AZ positioning function, an 802.11 BF WiFi sensing function, and a wireless communication function that shares an antenna with WiFi.

19. The multi-antenna device of claim 18, wherein when the first antenna and the second antenna jointly establish a first communication link of the at least one communication link with the external device, the processor is configured to execute following steps according to the antenna link configuration profile:
announcing a change in a capability of the multi-antenna device to maintain within the first communication link, so that the first antenna maintains the first communication link and the second antenna does not maintain within the first communication link.

20. The multi-antenna device of claim 18, wherein when the first function is the shutdown function, the processor is configured to shut down the second antenna or enable the second antenna to enter a doze state or a power saving state to reduce a power consumption of the multi-antenna device.
